(19) United States
(12) Patent Application Publication
(10) Pub. No.: US 2004/0164060 A1
(43) Pub. Date: Aug. 26, 2004

(54) HOLE DRILLING METHOD AND APPARATUS

(75) Inventors: Yoji Maeda, Kosei-cho (JP); Yutaka Tsukada, Kosei-cho (JP); Kimihiro Yamanaka, Kosei-cho (JP); Masaharu Yasuda, Yasu-cho (JP)

Correspondence Address: IBM MICROELECTRONICS, INTELLECTUAL PROPERTY LAW, 1000 RIVER STREET, 972 E, ESSEX JUNCTION, VT, 05452, US

(73) Assignee: INTERNATIONAL BUSINESS MACHINES CORPORATION, Armonk, NY (US)

(21) Appl. No.: 10/708,265

(22) Filed: Feb. 20, 2004

(30) Foreign Application Priority Data
Feb. 17, 2003 (JP) 2003-038532

(51) Int. Cl. B23K 26/38

(52) U.S. Cl. 219/121.71; 219/121.7

(57) ABSTRACT

A method and apparatus for drilling a hole through a printed circuit board is described using a laser beam such that the diameter of the top portion and the bottom portion of the hole are substantially equal. The laser beam is irradiated perpendicularly to a printed circuit board to drill a tapered hole having a top portion and a bottom portion wherein the diameter of the bottom portion is smaller than that of the top portion. Further, the laser beam 10 is irradiated to the tapered hole obliquely relative to the board 12 to equalize the diameters of the top and bottom portions to each other. By irradiating the laser beam 10 obliquely, a straight hole 14 can be formed.

### BACKGROUND OF INVENTION

1. Field of the Invention

The present invention is directed toward a method and apparatus for drilling holes in a printed circuit board (PCB) using a laser beam, and more particularly to a method and apparatus for drilling through-holes in PCBs for installing surface mount technology components, face plates, back-plane connectors and fasteners.

2. Background of the Invention

Conventionally, holes such as through-holes in printed circuit boards are formed using mechanical drills. The circuit and I/O pin densities of current semiconductor technologies drive a concomitant increase in PCB wiring density to accommodate the large number of I/O signals per integrated circuit. Considering the physical constraints of PCBs, the through-holes used to install surface mount devices begin to represent a significant amount of area that becomes unavailable for wiring.

However, if a mechanical drill is made thinner, the durability and reliability of the mechanical drill is compromised, and undesirable excursion or runout of the center axis upon rotation of the mechanical drill becomes an issue. Further, the cost of mechanical drill equipment increases markedly for the fine precision bits and methods required for PCB hole drilling. Lastly, formation of small diameter through-holes using mechanical drills may cause deformation of the holes and breakage of the mechanical drills, resulting in increased hole drilling costs and manufacturing time.

Current examples of PCB drilling methods include laser processing. The formation of the holes is carried out using a hole drilling apparatus incorporating a laser beam such as, for example, a carbon dioxide (CO₂) laser beam or an ultraviolet (UV) excimer laser beam. A PCB is placed on a moveable platform that can be positioned for drilling a hole. Positioning and focus of the laser beam is accomplished by adjusting a series of lenses and mirrors incorporated in the laser apparatus. The laser beam passes through the center of a condenser lens and is perpendicularly irradiated on the PCB. The laser beam is focused with two collimator lenses CL, and the diameter of the laser beam is adjusted using a mask.

As illustrated in FIGS. 8A and 8B, one drawback with prior art laser processing is that some of the energy of the laser is absorbed by the PCB causing the beam to taper as it traverses through the PCB. The tapering of the laser in turn causes unequal diameters at the incident and outgoing surfaces of the PCB.

Metal plating is sometimes applied to a side wall of the hole to mitigate the tapering effect, however, since the diameter of the bottom portion is small, the plating liquid may become more resistant to flow and failing to adhere properly to the PCB. Particularly, since through-holes are longer than via holes, there arise more cases where plating can not be achieved.

A processing method for preventing tapering of a hole is disclosed in Japanese Patent No. JP-A-H03-151182, wherein a focus position of a laser beam is raised and lowered, or a laser beam is rotated. By raising and lowering the focus position or rotating the laser beam, it is possible to increase a spot diameter of the laser beam. By increasing the spot diameter, the piercing diameter is increased so that there is no difference between the cutting width and the piercing diameter when switching from piercing to cutting. Upon switching the processing condition, it is possible to prevent burning in which molten metal flows out of the PCB at a particular point in processing.

Since the diameter of the hole formed becomes greater when the focus position is lowered than when the focus position is raised, a straight hole cannot be formed only by raising and the lowering the focus position. If the laser beam is rotated, a focus from a board is also rotated, as seen from FIG. 3 of Japanese Patent No. JP-A-H03-151182 so that the entire hole diameter is increased. However, since the laser beam is irradiated on the PCB perpendicularly thereto, energy of the laser beam is absorbed by the board, and therefore, a straight hole can not be formed even if the whole hole diameter is increased.

Conversely, Japanese Patent No. JP-A-H07-284975 discloses a method of forming a tapered hole with a laser by changing the angle of incidence of a laser beam with respect to the surface being irradiated. By irradiating a PCB from multiple directions at different angles with an excimer laser, the tapered hole is formed.

In the method of Japanese Patent No. JP-A-H07-284975, a straight hole is drilled by single irradiation of the excimer laser beam. Although it is effective in forming the tapered hole by changing the angle of the excimer laser beam, the straight hole can not be formed.

### SUMMARY OF INVENTION

Summary of the InventionThe present invention utilizes the property that a laser beam is tapered when it is irradiated onto a flat surface, and applies the laser beam obliquely to the board, i.e. not perpendicularly thereto. By applying the laser beam obliquely, part of a tapered portion of the laser beam becomes perpendicular to the board. By applying the laser beam from a plurality of directions, diameters of top and bottom portions of a formed hole are made equal to each other so that a straight hole can be formed.

Further, when forming multiple through-holes in one board, a laser beam is irradiated with respect to the desired pattern of multiple holes in turn so that temperature elevation of the holes can be suppressed. Consequently, carbonization of inner walls of the holes or generation of plasma in the holes is avoided.

One aspect of the present invention is to provide an apparatus and method for drilling a hole in a PCB with an excimer laser such that the diameter is equal for the top and bottom portions of the hole.

The method for drilling a hole in a PCB according to the present invention includes the following steps: (a) irradiating a laser beam on a surface of a PCB from a direction perpendicular thereto to thereby drill a hole in the board; (b) irradiating a laser beam into the hole from a direction inclined at a predetermined angle relative to the perpendicular direction; and (c) repeating step (b) until diameters of a top portion and a bottom portion of the hole become substantially equal to each other. When a laser beam is irradiated perpendicularly to the board, a tapered hole is drilled in the board. By applying a laser beam to the board obliquely at a predetermined angle, the tapered portion of the laser beam becomes perpendicular to the board. The predetermined angle is an angle inclined from about 2 to 5 degrees measured from a direction perpendicular to the board. By applying a laser beam to the board obliquely from a plurality of directions, a hole with equal diameters of the top and bottom portions may be formed.

Another aspect of the invention is directed toward a method for drilling multiple holes in a PCB using the following steps: (a) irradiating a laser beam that is perpendicular to the PCB surface in a number of predetermined positions to drill multiple holes in the PCB; (b) irradiating a laser beam into the holes drilled in a number of predetermined positions in turn from a direction inclined at a predetermined angle relative to the perpendicular direction; and (c) repeating step (b) until the diameters of the top portion and the bottom portion of each of the holes become substantially equal.

When forming multiple holes in the PCB, a laser beam is first irradiated at a number of predetermined positions on the PCB. Initially, each hole drilled in this manner will exhibit unequal diameters in the top and bottom portions of the hole. In the next step, a PCB is irradiated multiple times with a laser in a predetermined sequence of angles to eliminate the tapered segments of the hole and thereby equalize the diameters of the top and bottom portions of each hole. The predetermined angle is an angle inclined from about 2 to 5 degrees measured from a direction perpendicular to the PCB. In step (c), the laser beam is irradiated while changing a laser beam irradiation position along the circumferential direction of each hole.

Still another aspect of the present invention is directed towards a method of drilling a hole in a PCB using the following the steps: (a) irradiating a laser beam on a surface of a PCB from a direction inclined at a predetermined angle relative to the perpendicular of the surface of the board, in a number of predetermined positions on the board in turn to thereby drill a plurality of holes in the board; and (b) repeating step (a) until the diameters of the top bottom portions of each of the holes become substantially equal. The holes are formed by performing laser irradiation only from the inclined directions, i.e. without performing laser irradiation in the perpendicular direction.

A hole drilling apparatus of the present invention includes an oscillator producing a laser beam for drilling a hole in a PCB; a lens through which the laser beam passes and which determines the angle of the laser beam relative to the board depending on a laser beam passing position of the lens; and a mirror changing the laser beam passing position of the lens depending on the number of times the PCB has been irradiated. The present invention changes an angle of a laser beam produced by the oscillator relative to the PCB by the use of the lens and the mirror. By irradiating the laser beam obliquely to the PCB, a straight hole is formed.

### BRIEF DESCRIPTION OF DRAWINGS

FIGS. 1A to 1D illustrate a hole drilling method of the present invention, wherein FIG. 1A shows a laser beam irradiated perpendicularly, FIG. 1B shows a laser beam irradiated obliquely, FIG. 1C shows a laser beam irradiated obliquely in a direction different from that in FIG. 1B, and FIG. 1D shows a completely formed hole;

FIG. 2 illustrates a structure of a hole drilling apparatus of the present invention;

FIG. 3A is a plan view showing a condenser lens, wherein an outer peripheral portion thereof is identified by hatching;

FIG. 3B shows the inclination of laser beams relative to the condenser lens;

FIGS. 4A to 4C show a method of forming a plurality of holes, wherein FIG. 4A is the diagram in which a laser beam is applied to the holes in turn, FIG. 4B is the diagram in which a laser beam is further applied to the holes in turn, and FIG. 4C is the diagram in which a laser beam is still further applied to the holes in turn;

FIG. 5 illustrates the temperature variation of each of the holes and timing of laser irradiation when the holes are formed by the method shown in FIGS. 4A to 4C;

FIG. 6 shows a method of irradiating a laser beam with respect to a plurality of holes in turn, and carrying out trepanning in each of the holes;

FIG. 7 depicts a laser beam at an inclined angle and the effect of a condenser lens on the angle of incidence of the laser beam with respect to a printed circuit board; and

FIGS. 8A and 8B show a conventional hole drilling method, wherein FIG. 8A illustrates a laser beam irradiated perpendicularly, and FIG. 8B illustrates the finished drilled hole.

### DETAILED DESCRIPTION

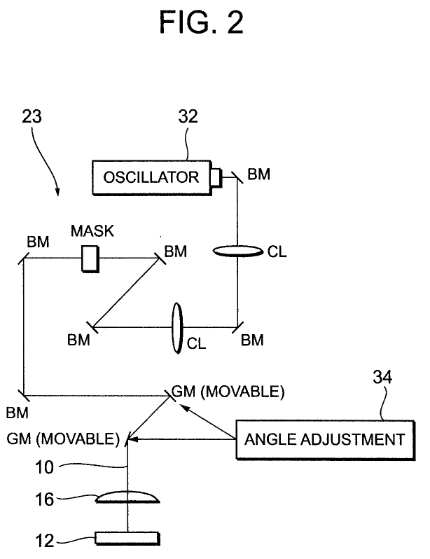

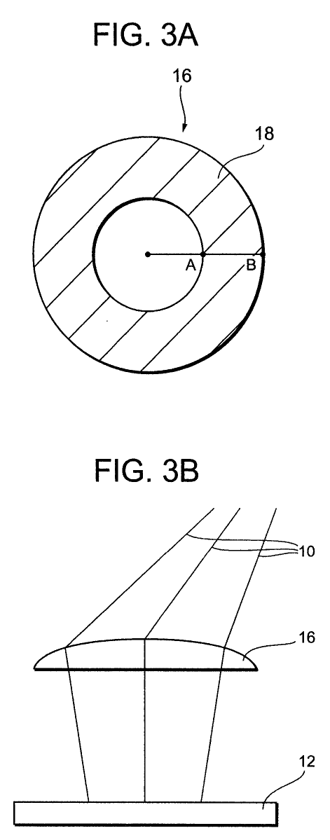

The present invention is directed toward a method and apparatus for drilling a hole in a PCB with a uniform diameter. As shown in FIG. 3B, the position at which a laser beam 10 passes through a condenser lens 16 is changed with the adjustment of a pair of Galvano mirrors GM, which then adjust an incident angle of the laser beam 10 relative to a PCB 12. A hole drilling apparatus 23 shown in FIG. 2 includes angle adjustment device 34 for adjusting the angles of the Galvano mirrors GM. The angle of the laser beam 10 relative to the board 12 changes depending on the number of times the PCB 12 board has been irradiated by the laser. Changing the position of the condenser lens 16 through which the laser beam 10 passes is accomplished by adjusting the angles of the Galvano mirrors GM.

For PCB 12 with a thickness of, for example, 0.4 mm, the diameter of the laser beam forming the hole is adjusted in the range of from about 50 to 100 microns. This process employs a carbon dioxide laser beam or an ultraviolet laser beam. With collimator lenses CL and a Mask 15, the diameter of the laser beam 10 is adjusted in the range of from about 50 to 100 microns. In the laser irradiation step, the number of pulses of the laser beam 10 in one irradiation is optional, for example, one, and the frequency of the oscillator 32 producing the pulses is, for example, about 1 kHz.

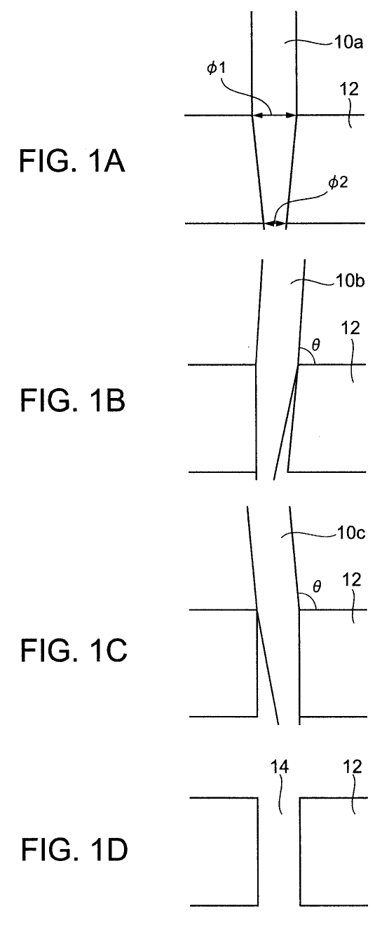

As shown in FIG. 1A, a first laser beam 10a is perpendicularly irradiated on the board 12 by adjusting the angles of the two Galvano mirrors GM so that the first laser beam 10a passes through the center of the condenser lens 16. Because some of the energy of the laser beam 10 is absorbed by the board 12, the first laser beam 10a is tapered as it penetrates the surface of the PCB 12. Therefore, a hole drilled by irradiation of the first laser beam 10a exhibits a smaller diameter in the lower portion of the hole and a larger diameter in the top portion of the hole. For example, if the diameter f1 of the top portion of the hole is 60 microns, the diameter f2 of the bottom portion may be reduced by as much as 30 microns, effectively halving the diameter of the bottom portion. To clarify further, the top portion of the hole is the incident side which the laser beam 10 initially penetrates.

Then, as shown in FIG. 1B, a second laser beam 10b is irradiated on the PCB 12 at an oblique angle by adjusting the angles of the Galvano mirrors GM with the angle adjustment device 34 such that the second laser beam 10b passes through an outer peripheral portion of the condenser lens 16.

As shown in FIG. 3A, an outer peripheral portion 18 of the condenser lens 16 is, for example, a portion of the condenser lens 16 radially outward from a concentric circle having a radius that is half the radius of the condenser lens 16. When the angles of the Galvano mirrors GM are adjusted so that the laser beam 10 passes through the outer peripheral portion 18, the laser beam 10 is inclined relative to the board 12 as shown in FIG. 3B. The angle of the laser beam 10 relative to the PCB 12 is from about 87 to 88 degrees measured from the planar surface of the PCB 12 when the laser beam 10 passes through the neighborhood of a middle point A of a segment directed radially outward from the center O of the condenser lens 16 shown in FIG. 3A; and from about 85 to 86 degrees measured from the planar surface of the PCB 12 when the laser beam 10 passes through the neighborhood of the outer periphery B of the condenser lens 16.

When PCB 12 is irradiated, some laser energy is absorbed by the PCB 12 causing the laser beam 10 to become tapered as it passes through the PCB 12. As shown in FIG. 1B, the second laser beam 10b is inclined such that the tapered portion of the second laser beam 10b is now perpendicular to the board 12. The angle q1 of the second laser beam 10b relative to the PCB 12 is from about 85 to 88 degrees measured from the planar surface of the PCB 12. A portion of the hole drilled by irradiation of the second laser beam 10b inclined relative to the perpendicular of PCB 12 forms an inner wall perpendicular to PCB 12 that is not tapered.

As further shown in FIG. 1C, a third laser beam 10c is applied obliquely from an opposite direction relative to that in FIG. 1B. The angle q2 of the third laser beam 10c is from about 92 to 95 degrees measured from the planar surface of the PCB 12.

The diameters of the top and bottom portions of the hole can not be fully equalized by irradiating the laser beam 10 inclined relative to the PCB 12 from two directions. Therefore, the laser beam 10 is applied repeatedly from a plurality of directions by adjusting the angles of the Galvano mirrors GM. This is accomplished through successive adjustment of the position of the condenser lens 16 through which the laser beam 10 passes. The laser beam 10 is irradiated from a plurality of directions at an angle of from about 2 to 5 degrees from the perpendicular direction relative to the PCB 12. Using this method, a hole 14 formed by the repeated application of the laser beam 10 exhibits substantially uniform diameter throughout with no tapered segments as shown in FIG. 1D. That is, the diameters of the top and bottom portions of the hole 14 become substantially equal to each other so that a straight hole 14 is formed. Although the laser beam 10 is irradiated obliquely from a plurality of directions in the foregoing description, the direction of the laser beam 10 may be changed so that irradiation positions of the laser beam 10 describe a circle. By implementing the foregoing processes, the diameters of the top and bottom portions of the hole 14 become equal to each other, and therefore, plating on a side wall of the hole 14 can be reliably achieved.

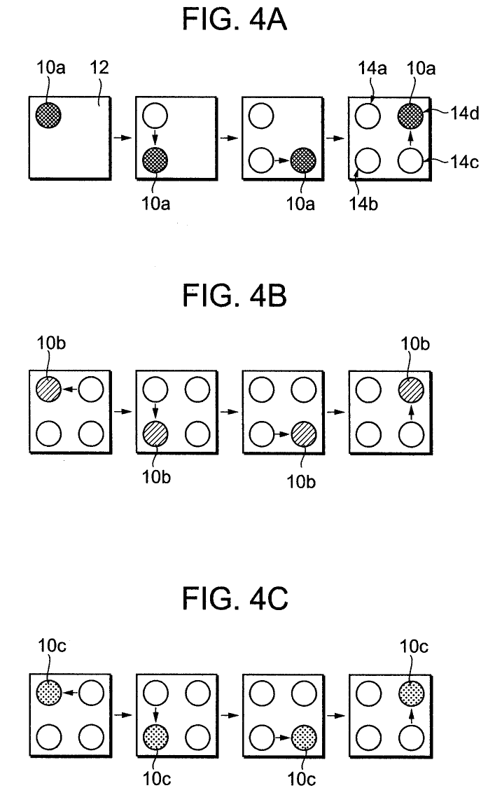

Typically, a plurality of through-holes are provided for one PCB 12. This configuration is illustrated FIGS. 4A through 4C. Holes 14a, 14b, 14c, and 14d are formed in a single PCB 12. In the progression shown in FIG. 4A, a first laser beam 10a is irradiated on the PCB 12 at different positions, in turn, where the holes 14a, 14b, 14c, and 14d are drilled. The first laser beam 10a is irradiated on the board 12 perpendicularly thereto. Each hole drilled in this manner is tapered at the bottom. For the situation where each tapered hole is not completely drilled by one laser irradiation, the process is repeated until the PCB 12 is perforated.

In the progression shown in FIG. 4B, a second laser beam 10b is irradiated on the PCB 12 at an oblique angle to remove the tapered portion of each hole. The second laser beam 10b is applied to the holes 14a, 14b, 14c, and 14d in turn.

In the progression shown in FIG. 4C, a third laser beam 10c is used to irradiate the hole from a different direction from that shown in FIGS. 4A and 4B. The third laser beam 10c is similarly applied to the holes 14a, 14b, 14c, and 14d in turn.

Subsequent to the progression shown in FIG. 4C, the laser beam 10 is likewise irradiated obliquely on the PCB 12 and applied in sequence to holes 14a, 14b, 14c, and 14d. Specifically, irradiation of the inclined laser beam 10 is successively carried out from one direction with respect to holes 14a, 14b, 14c, and 14d in turn while changing the direction of the laser beam 10 at each step. In FIG. 2, the PCB 12 is placed on a stage (not shown), and the stage is moved to displace a position of the PCB 12 for drilling the plurality of holes 14a, 14b, 14c, and 14d. Laser irradiation from an oblique direction is repeated until the holes 14a, 14b, 14c, and 14d are formed.

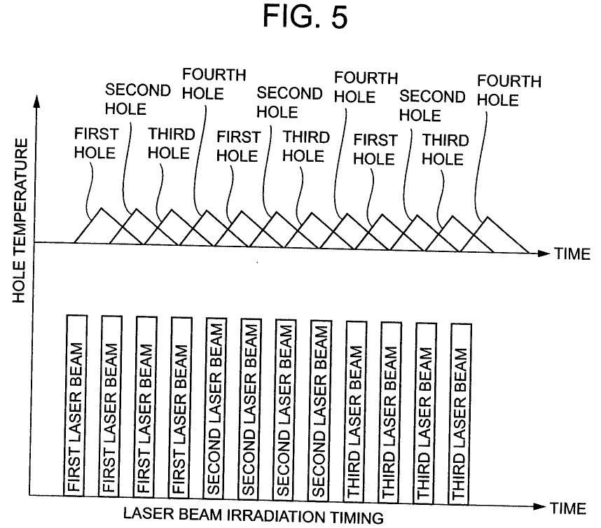

To form a series of through-holes, the laser beam 10 irradiates the PCB 12 in a series of iterative pulses moving from one hole location to the next in sequence. The laser beam 10 does not necessarily perforate the PCB 12 on the first iteration. As shown in FIG. 5, even if the local temperature of the PCB 12 near each of the holes 14a, 14b, 14c, and 14d rises during one laser irradiation, it is cooled for a period not less than one interval of laser irradiation as between two distinct holes. This interval of time ensures that no carbonization of the PCB 12 will occur that would otherwise be caused by generation of plasma or temperature elevation. The diameters of the top and bottom portions of the holes 14a, 14b, 14c, and 14d are also equalized to each other.

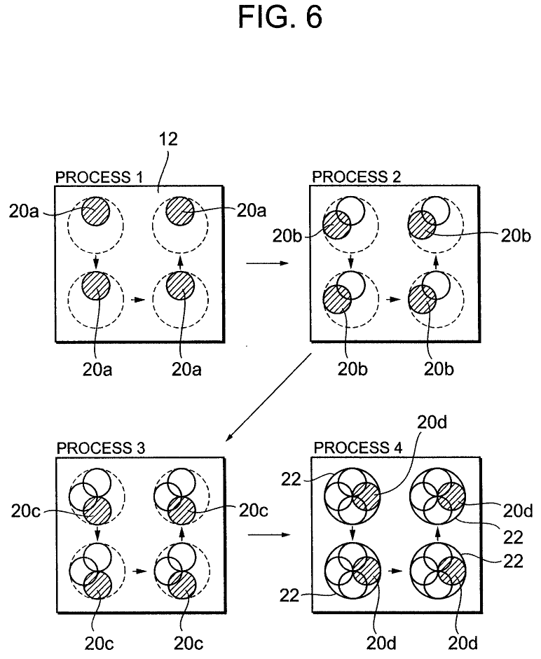

Another aspect of the invention is directed towards a method of forming a plurality of holes each having a diameter greater than the diameter of the laser beam 10 in one PCB 12. As shown in PROCESS 1 of FIG. 6, a first laser beam is irradiated on the PCB 12 at different locations to drill small holes 20a. The first laser beam is applied obliquely to the PCB 12 such that part of a tapered portion of the first laser beam becomes perpendicular to the PCB 12. The formed small hole 20a is smaller than the target hole 22.

As shown in PROCESS 2, 3 and 4 the small holes 20a, 20b, 20c, and 20d are formed by irradiation of a second, third, and fourth laser beam. In each case, the laser beam 10 is applied obliquely to the PCB 12 with respect to the plurality of holes 22 in a series of steps.

If each of the small holes 20a, 20b, 20c, and 20d penetrating the PCB 12 can not be drilled through one laser irradiation, PROCESSES 1, 2, 3, and 4 are performed repeatedly until the small holes 20a, 20b, 20c, and 20d penetrate the PCB 12. Specifically, to form multiple holes 22, laser irradiation is successively carried out from one direction with respect to the holes 22 while changing the direction of the laser beam 10 with respect to each of the holes 22. The small holes 20a, 20b, 20c, and 20d are drilled so as to be continuous with each other. Until the holes 22 are formed, laser irradiation from an oblique direction is repeated.

For each PROCESS shown in FIG. 6 the location on the PCB to which the laser beam 10 is applied is changed with respect to each of the holes 22. The laser beam is not irradiated continuously with respect to each of the holes 22, but irradiated in sequence with respect to the plurality of holes 22. Since there is discrete time interval in laser irradiation with respect to each of the holes 22, it is possible to suppress local temperature elevation in and near the holes 22. In this manner, generation of plasma in the holes 22 or carbonization of the board is avoided. Further, by applying the laser beam 10 obliquely to the board 12 so as to cause a tapered portion of the laser beam 10 to be perpendicular to the board 12, it is possible to form each hole 22 with an equal diameter on the incident and outgoing sides of the PCB 12.

In FIG. 6, each hole 22 is formed by the four small holes 20a, 20b, 20c, and 20d. However, the number of the small holes is not limited to four.

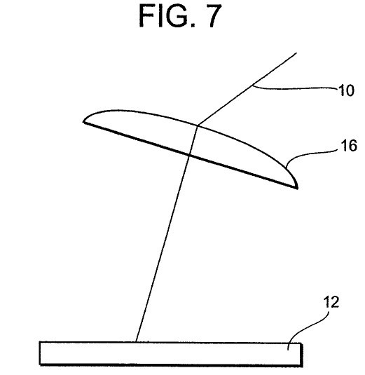

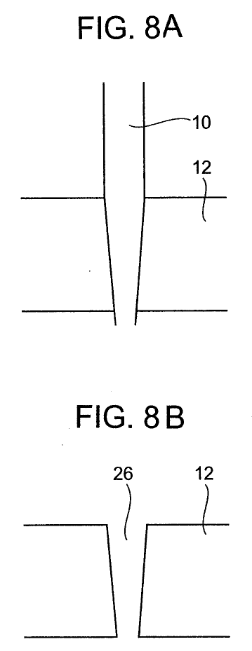

As shown in FIG. 3B, the angles of the Galvano mirrors GM are adjusted to change the point on the condenser lens 16 through which the laser beam 10 passes. However, as shown in FIG. 7, the angle of the condenser lens 16 may also be independently adjusted. The angle of the condenser lens 16 is adjusted depending on the number of times of irradiation of the laser beam 10. Further, the angle and position of the laser beam 10 relative to the board 12 may be altered by changing the angles of both the Galvano mirrors GM and the condenser lens 16.

FIG. 6, illustrates the procedure for drilling multiple through-holes 22 using a laser with a diameter less than the hole to be drilled. When drilling the small holes 20a, 20b, 20c, and 20d, the laser beam 10 is applied obliquely to the board 12 such that the diameters of the top and bottom portions of the hole 22 are made equal to each other.

While the invention has been described in detail, the foregoing description is in all aspects illustrative and not restrictive. It is understood that numerous other modifications and variations can be devised without departing from the scope of the invention. For example, the first laser beam 10a is irradiated perpendicularly to the board 12 in FIGS. 1A and 4A. However, the hole 14 may be formed only by laser irradiation inclined relative to the board 12, i.e. without irradiating the first laser beam 10a perpendicularly.

What is claimed is:

1. A method of forming a hole in a board, comprising the steps of:
(a)irradiating a laser beam on a surface of said board from a direction perpendicular thereto to thereby drill a hole in said board;
(b)irradiating a laser beam onto said hole from a direction inclined at a predetermined angle relative to said perpendicular direction; and
(c)repeating the step (b) until diameters of a top portion and a bottom portion of said hole become substantially equal to each other.

2. The method according to claim 1, wherein said predetermined angle is selected within the range of from about 2 to 5 degrees measured from a perpendicular direction relative to said board.

3. A method of forming a plurality of holes in a board, comprising the steps of:
(a)irradiating a laser beam on a surface of said board from a direction perpendicular thereto in a plurality of predetermined positions thereof in turn to thereby drill a plurality of holes in said board;
(b)irradiating a laser beam onto the holes drilled in said plurality of predetermined positions in turn from a direction inclined at a predetermined angle relative to said perpendicular direction; and
(c)repeating the step (b) until diameters of a top portion and a bottom portion of each of said holes become substantially equal to each other.

4. The method according to claim 3, wherein said predetermined angle is selected within the range of from about 2 to 5 degrees measured from a perpendicular direction relative to said board.

5. The method according to claim 4, wherein the step (c) repeating the step (b) includes a step of irradiating a laser beam while changing a laser beam irradiation position along a circumferential direction of each of said holes.

6. A method of forming a plurality of holes in a board, comprising the steps of:
(a)irradiating a laser beam on a surface of said board from a direction inclined at a predetermined angle relative to a direction perpendicular to the surface of said board, in a plurality of predetermined positions of said board in turn to thereby drill a plurality of holes in said board; and
(b)repeating the step (a) until diameters of a top portion and a bottom portion of each of said holes become substantially equal to each other.

7. The method according to claim 6, wherein said predetermined angle is selected within the range of from about 2 to 5 degrees measured from a perpendicular direction relative to said board.

8. The method according to claim 7, wherein the step (b) repeating the step (a) includes a step of irradiating a laser beam while changing a laser beam irradiation position along a circumferential direction of each of said holes.

9. A hole drilling apparatus comprising:
an oscillator producing a laser beam for drilling a hole in a board;
a lens through which the laser beam passes and which determines an angle of the laser beam relative to said board depending on a laser beam passing position of said lens;
a mirror changing the laser beam passing position of said lens depending on the number of times of laser beam irradiation to said board;
a mask having the ability to change the diameter of the laser beam; and
a moveable stage to which the board is coupled having the capability to adjust the position of the board with respect to the laser beam.

10. The hole drilling apparatus according to claim 9, wherein an angle of said mirror is adjustable for changing the laser beam passing position of said lens.
